(19) United States
(12) Patent Application Publication
(10) Pub. No.: US 2009/0306882 A1
(43) Pub. Date: Dec. 10, 2009

(54) SYSTEM, APPARATUS, OR METHOD FOR ENHANCED ROUTE DIRECTIONS

(75) Inventors: Siddharth Vijayakrishnan, Bangalore (IN); Ankit Kumar Agrawal, Bangalore (IN); Arun Singhal, Bangalore (IN); Abhishek Seth, Bangalore (IN); Anand Sasidharan, Bangalore (IN); Shivakumar Ganesan, Bangalore (IN)

Correspondence Address: BERKELEY LAW & TECHNOLOGY GROUP LLP, 17933 NW EVERGREEN PARKWAY, SUITE 250, BEAVERTON, OR, 97006, US

(73) Assignee: YAHOO! INC., Sunnyvale, CA (US)

(21) Appl. No.: 12/136,700

(22) Filed: Jun. 10, 2008

(51) Int. Cl. G01C 21/36

(52) U.S. Cl. 701/200

(57) ABSTRACT

Embodiments of methods, apparatuses, devices and systems associated with generating a textual explanation of a route including POI information are disclosed.

### FIELD

Embodiments relate to the field of route directions, and more specifically to generating enhanced route directions.

### BACKGROUND

Drivers may from time to time desire assistance navigating a route to a destination. For example, if a driver is in an unfamiliar area or driving to a new location it may be advantageous for the driver to have one or more directions or other assistance in navigating a route to an intended destination. Therefore, under some circumstances, it may be advantageous to provide a driver with additional assistance in navigating a route.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description when read with the accompanying drawings in which:

FIG. 1 is a flowchart of a method in accordance with an embodiment;

FIG. 2 is a schematic diagram of a display interface including one or more route directions in accordance with an embodiment;

FIG. 3 is a schematic diagram of an apparatus in accordance with an embodiment; and

FIG. 4 is a schematic diagram of a system in accordance with an embodiment.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, procedures, components and/or circuits that would be known by one of ordinary skill have not been described in detail so as not to obscure the claimed subject matter.

Reference throughout this specification to “one embodiment” or “an embodiment” means that a particular feature, structure, or characteristic described in connection with the embodiment is included in at least one embodiment of claimed subject matter. Thus, appearances of the phrase “in one embodiment” or “an embodiment” in various places throughout this specification are not necessarily all referring to the same embodiment. Furthermore, the particular features, structures, or characteristics may be combined in one or more embodiments.

The ability to map a route between two locations is available via the internet. For example, Yahoo! maps is able to provide the following routing directions between Victoria Road in Bangalore and Mahatma Gandhi Road in Bangalore:
1 Start at VICTORIA ROAD, BANGALORE, go—0.2 km
2 Turn Left on TRINITY CHURCH RD, go—0.6 km
3 Turn Left on MAHATMA GANDHI RD, go—0.5 km
4 Arrive at your destination

However, it may be advantageous to provide a system or method with additional capabilities, such as generating from stored geographic information a textual explanation of route directions that includes point of interest (POI) information, wherein the point of interest information may include at least one of the following: specifying the number of potential turns between two actual turns; landmark information based at least in part on proximity to an actual turn; or one or more political boundaries. For example, the textual explanation of a route may be generated by one or more computing platforms. As used herein, POI information means a point of interest along a route that a user/traveler may actually observe while traversing the route and therefore have the opportunity to employ it as a reference point to at least in part assist the user/traveler with traversing the route.

As one example of how this information may be combined with the above described routing directions, consider the same route between Victoria Road in Bangalore and Mahatma Gandhi Road in Bangalore. For example, the route may be presented to a user as follows:
1 Straight (0.2 km) on Victoria Rd
2 2nd Left onto Trinity Church Rd, go 0.6 km.
Enter Ashok Nagar.
3 Left (past Indus Ind Bank on the left) onto Mahatma Gandhi Rd, go 0.5 km
4 Arrive at destination

These directions include POI information at least in part to assist a drive in following a route. For example, the second direction includes potential turn information, “2^{nd} left”. The POI information, “2^{nd} left,” may assist a driver to identify or navigate a left turn onto Trinity church road, for example. In this example, it may be easier for a driver to count a number of potential left turns before an actual left turn than it would be for a driver to monitor a distance traveled before an actual left turn. In addition, between the second and third directions administration area information has been added, “Enter Ashok Nagar”. The administration area information may likewise assist a drive in following or navigating the intended route. For example, in one or more regions routes may, under some circumstances, typically be described in terms of entering or exiting one or more localities or political areas. In this example, adding administration information may be useful in assisting a drive to navigate an intended route. In further addition, the third direction includes POI information relating to a landmark “past Indus Bank on the left.” The POI information relating to a landmark may assist a driver with navigating a turn onto Mahatma Gandhi Road. Of course, these are merely example textual directions including POI information and claimed subject matter is not limited in this regard.

Point of interest information for landmarks may be obtained from a variety of sources, such as one or more commercial internet sites that collect such information. In an embodiment, a system may search for various websites or databases, such as using a web crawler, for example, to obtain POI information from one or more internet sources. In addition, POI information may be obtained from one or more commercial data providers, such as CE Infosystems, of India, for example. POI information in this embodiment may include the name of a landmark, a category associated with the landmark or position of the landmark, such as one or more latitudes or longitudes associated with the landmark.

In an embodiment, POI information may also be categorized, such as by type of landmark. Examples of categories include Automated Teller Machines (ATMs), hospitals, grocery stores, petrol stations, etc. In an embodiment, categorizing POIs may allow different categories to be assigned different relevance scores or values. In an embodiment, relevance may be determined based at least in part on an assessment or estimate of how useful a particular POI may be in assisting a driver to follow route instructions. For example, an instruction to take a turn after passing a more visible petrol station may be more useful information than an instruction to take a turn after passing a small, less visible, ATM. In an embodiment, it may also be possible to subcategorize a particular category, so as to give preference to a particular brand or company, for example. In an embodiment, for example, ICICI ATMs may be more visible than HSBC ATMs. In this embodiment, the ICICI ATMs may be assigned to a special subcategory with respect to other ATMs. In another embodiment, POIs associated with a particular company or brand may be assigned to a special subcategory based at least in part on a contractual relationship with the particular company.

In accordance with an embodiment, a relevance function or operation may be applied to one or more POIs at least in part to determine a relevance score or value for the one or more POIs depending at least in part on a category associated with the one or more POIs and a distance from a given edge or intersection between two or more edges of the one or more POIs, for example. In addition, a POI score or value may depend at least in part on the POI's specific location relative to an edge. In an embodiment, for one or more categories of POIs, a relevance function or operation may be described according to one or more of the following which may have one or more known computational approaches or techniques for particular implementations:

Linear decaying: such as if a relevance value may decrease linearly as a distance from a particular intersection, turn, or edge increases;

Piece-wise linear decaying: such as if a relevance value may decrease linearly for one or more distances, but the actual rate of the decrease may differ as the distance of the POI from a particular intersection, turn, or edge increases;

Abrupt decaying: such as if a relevance value may remain constant within an interval, but differ over one or more distances. In this circumstance, a relevance value may decrease abruptly if the distance increases and falls in another interval. In addition, there may be a cut off, such as at an end of a particular interval after which a relevance value may be approximated as zero.

In an embodiment (1), it may be desirable to have the ability to associate a POI with a particular route based at least in part on a consideration of particular points along a route where a POI may be useful, and (2) be desirable to identify which POI, if more than one is available for a particular point along a route, to employ. For the first issue, in this particular embodiment, one may employ points on a route before one or more turns to consider for associating POIs with the route. For example, under some circumstances, a driver may desire additional assistance with turns, while being able to traverse straight portions of a route with less additional assistance. However, POIs could also be associated with straight segments of a route as well. For the second issue, one may choose a POI having a threshold relevance, or a POI having a highest relevance of available POIs to associate with the route. In this embodiment, relevance may be determined at least in part by a relevance function or operation as described above.

In an embodiment, a system may generate a structured representation of a route, such as by using one or more computing platforms having an application program, code, or a module for generating a structured representation of routing information based at least in part on stored geographic information. As used herein, a “structured representation of a route” may refer to data depicting a route, wherein the data is stored in a format capable of being operated on by one or more application programs or modules for a variety of purposes, including, for example, conversion to text. Examples, without limitation, may include node and edge data provided in an XML or other format. For example, a computing platform executing a routing program may, based at least in part, on stored geographic information, determine a sequence of one or more edges. In this context an edge may refer to a representation of a segment of a road that is not intersected by another road or road segment, for example. The routing program may be configured to split a sequence of one or more edges into multiple parts. In an embodiment, the routing program may further be configured to define potential turns as points where one or more edges cross if an angle of intersection between the one or more edges exceeds a threshold value, such as 20 to 30 degrees, for example. Of course these are merely examples relating to generating a structured representation of a route and claimed subject matter is of course not limited in this regard.

In at least one embodiment, a system or apparatus may determine any POIs on the side of a first edge corresponding to a turn direction, such as by looking up POI information for a potential turn in memory, such as POI information stored in a database, hash table, lookup table, or the like. For example, if a particular turn is a left turn, the system may look for POI information on the left side of an edge defining the turn. In this embodiment, the system may choose one or more POIs in proximity to an edge defining the turn. The system may further calculate a relevance value or score for any of the chosen POIs based at least in part on an appropriate relevance function or operation for the chosen POIs. The system may choose a POI which has a threshold relevance value, or a highest relevance value of available POIs. The process of finding POIs in the vicinity of an edge, on one side, calculating a relevance value or score for the POIs and picking a useful POI, which has a threshold relevance value or score, may, under some circumstances, be done offline to increase real time performance. In an embodiment, the selected POI may be stored in a fast indexing data structure, such as one or more tables, for example, to retrieve it later in real time. If there are no POIs on the side of an edge corresponding to the turn direction, the system may choose a desirable POI on another side in an analogous fashion. A textual explanation of a route may then be generated based at least in part on the selected POIs and the structured representation of a route. Of course, these are merely example relating to POI information and route directions and claimed subject matter is not limited in this regard.

Another type of POI information may comprises administration information or administration areas, which may represent an area covered by a locality, city, state, etc, such as one or more political boundaries. Administration areas may be represented in the form of shapes. A shape may comprise a sequence of points on the surface of the earth, represented by a latitude or a longitude, for example. Administration areas may, under some circumstances, be categorized in a hierarchical manner. For example, a high level administration area may include one or more lower level administration areas which, in turn, may include one or more further lower level administration areas. For instance, a city being a higher level administration area may include one or more localities which may comprise lower level administration areas. One way of adding administration area information in the driving directions may be to report events of entering or leaving an administration area. In one particular embodiment, preference may be given to including higher level administration area changes if changes are occurring at multiple levels.

One or more edges may be associated with proximal administration areas. In one embodiment, the system may traverse the sequence of edges representing the route and, for one or more connected edges, the system may check for any change in administration area names associated with the edges. The check may be performed for all the levels of administration areas and all the changes, if there are any, may be tagged with the junction of the two edges. The outcome of this process may be that one or more of the administration-area-name changes may be tagged with the appropriate junctions. Of course, this is merely an example relating to administration area and other approaches to administration areas are within the scope of claimed subject matter.

As discussed above, POI information may also include a number of possible turns that exist between actual turns a driver should follow. In an embodiment, textual directions may include the number of possible turns between the actual turns a driver is to follow, such as, to assist the driver if the actual turn is difficult to identify. For example, if the actual turn comprises an unnamed or poorly marked road the textual directions may instruct the driver to take an actual turn a determined number of potential turns after a clearly marked road or other identifiable POI information such as a landmark or geographic boundary.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “storing,” “authenticating,” “authorizing,” “determining” or the like refer to the actions or processes that may be performed by a computing platform, such as a computer or a similar electronic computing device, that is operable to manipulate or transform data represented as physical, electronic or magnetic quantities or other physical quantities within the computing platform's processors, memories, registers, or other information storage, transmission, reception or display devices. Accordingly, a computing platform refers to a system or a device that includes the ability to process or store data in the form of signals. Thus, a computing platform, in this context, may comprise hardware, software, firmware or any combination thereof. Further, unless specifically stated otherwise, a process as described herein, with reference to flow diagrams or otherwise, may also be executed or controlled, in whole or in part, by a computing platform.

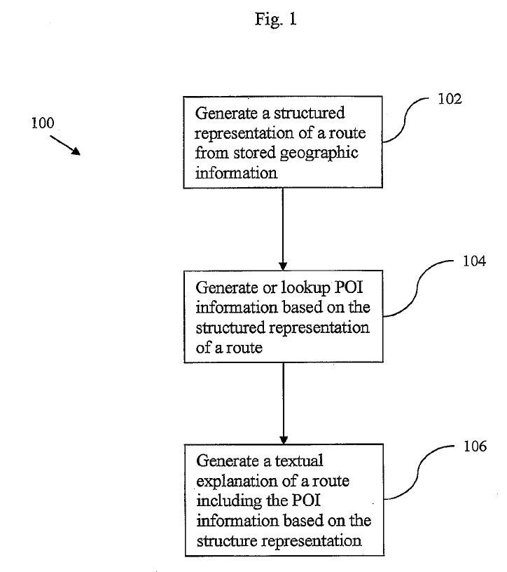

FIG. 1 is a flow chart of a method in accordance with an embodiment 100. With regard to embodiment 100, a system or process may generate a textual explanation of a route including point of interest (POI) information from stored geographic information, as described above, for example. With regard to box 102, one or more computing platforms may generate a structured representation of a route, based at least in part on a user query, such as by executing one or more routing application programs, code, or modules to generate a route navigating between a starting point and an end point associated with the user query. In an embodiment, a structured representation of a route may comprise route data in a format such as extensible markup language (XML), or JavaScript Object Notation (JSON), for example. For example, a user may initiate a query via a graphical interface or web page displayed on a computing platform and submit that query to one or more computing platforms to generate a structural representation of a route. In an embodiment, POI information may comprise landmark information, number of potential turn information, administration area information or the like. In an embodiment, a computing platform executing a routing program, code, or a module may be configured to generate a route in the form of a sequence of edges. In this embodiment, the routing program, code, or module may be configured to split a sequence of edges corresponding to a generated route into multiple parts, such as portions where an angle between one or more edges exceeds a threshold value, such as 20 to 30 degrees for example. In this embodiment, points along a route where edges intersect at an angle greater than the threshold value may be regarded as turns along the route. Of course, this is merely an example relating to generating a structured representation of a route and claimed subject matter is not limited in this regard.

With regard to box 104, a computing platform may selectively include POI information for one or more aspects of a structure representation of a route, such as by generating or looking up POI information for one or more portions of a structured representation of a route, for example. In this embodiment one or more computing platforms may determine POI information based at least in part on the structured representation of a route and selectively include the POI information along with the structured representation of the route. In an embodiment, the computing platform may choose POIs that are in proximity to one or more turns along a structured representation of a route. In addition, as discussed more fully below, the computing platform may calculate a relevance value or score of one or more chosen POIs using one or more relevance functions. Under some circumstances, determining POIs in proximity to one or more turns and calculating a relevance score for one or more POIs may be done separate from or in advance of generating a route, such that the information may be stored, for example in a database, table, or the like, and looked up by a routing program, for example.

With regard to box 106, a computing platform may generate a textual explanation of a route based at least in part on the structural representation of a route. For example, a computing platform may associate street names, distances, and turn directions with one or more edges or intersections of edges from the structural representation of a route. In addition, a computing platform may include the generated POI information along with the textual representation of a route, as shown above, for example. One or more computing platforms may, in addition, transmit the generated textual explanation of a route along with the POI information to another computing platform for display to a user.

In an embodiment, landmark information may comprise information intended to identify one or more buildings or structures, including, name, type, category, purpose, function, or a combination thereof, and having a proximity with one or more intersections. Examples of one or more buildings or structures include retail or government establishments, such as libraries, gas stations, grocery stores, etc. In an embodiment, landmarks may be separated in to one or more categories. For example, categories of landmarks may include Automated Teller Machines (ATMs), hospitals, grocery stores, petrol stations, etc. In an embodiment, categorizing POIs may allow different categories to be assigned different relevance scores or values. In an embodiment, relevance may be determined based at least in part on an estimate of how useful a particular POI may be in assisting a driver to follow route instructions. For example, an instruction to take a turn after passing a more visible petrol station may be more useful information than an instruction to take a turn after passing a small, less visible, ATM. In an embodiment, it may also possible to subcategorize a particular category of landmarks, so as to give preference to a particular brand or company, for example. In an embodiment, for example, ICICI ATMs may be more visible than HSBC ATMs. In this embodiment, the ICICI ATMs may be assigned to a special subcategory with respect to other ATMs. In another embodiment, POIs associated with a particular company or brand may be assigned to a special subcategory based at least in part on a contractual relationship with the particular company.

In an embodiment, number of potential turn information may comprise specifying a number of potential turns between two actual turns. For example, the textual explanation of a route may include information such as a number of potential turns between a first actual turn and a second actual turn, such as a number of potential turns from one road onto one or more other roads in one or more directions. For example, the textual explanation of a route may include a statement such as “take third right turn onto” a road or street along an intended route. Under some circumstances, however, number of potential turn information may not be beneficial to a driver. For example, if a number of potential turns between actual turns exceeds a threshold value or if a distance between potential turns and actual turns exceeds a threshold value then potential turn information may no longer assist a driver to navigate an intended route. For example, if there are more than 5-7 potential turns or greater than 7-12 kilometers between actual turns, it may not be beneficial to a driver to include potential turn information. Of course, this is merely an illustrative example relating to potential turn information and claimed subject mater is not limited in this regard.

In an embodiment, administration information or administration areas, may comprise one or more areas covered by a locality, city, state, etc, such as one or more political boundaries. Administration areas may be represented in the form of shapes. A shape may comprise a sequence of points on the surface of the earth, represented by a latitude or a longitude. Administration areas may, under some circumstances, be categorized in a hierarchical manner. For example, a high level administration area may include one or more lower level administration areas which, in turn, may contain one or more further lower level administration areas individually. For instance, a city being a higher level administration area may include one or more localities which may comprise lower level administration areas. One way of adding administration area information in the driving directions may be to report events of entering or leaving an administration area. In a particular embodiment, preference may be given to mentioning high level administration area changes if changes are occurring at multiple levels. Under some circumstances it may be more desirable to include information relating to entering an administration area rather than information about leaving an administration area.

In an embodiment, a computing platform may determine which, if any, of a variety of POI information to include with a textual explanation of a route based at least in part on a number of factors. For example, if the textual explanation of a route includes a turn between two well marked or easily identifiable roads, a computing platform may determine that no additional POI information should be included to assist a driver. If, however, an aspect of a route may benefit from POI information, such as a turn involving one or more poorly marked, less visible, or less well known roads, a computing platform may determine POI information to assist a driver with that aspect of the textual explanation for a route. For example, if a textual explanation of a route directs a driver to turn onto a poorly marked road, it may be beneficial to include POI information to assist the driver to successfully navigate that turn.

In an embodiment, once it has been determined that POI information may be beneficial to an aspect of a textual explanation of a route, a computing platform may determine, which POI information to include. For example, a computing platform may determine a relevance value for one or more POIs associated with a particular aspect of a route, such as a particular turn. A relevance value may be based at least in part on a variety of aspects associated with a particular POI, including a position or distance of a POI relative to a particular aspect of a route, how visible a POI may be from the route, how big a POI is, what category a particular POI is in, etc. For example, under some circumstances, a computing platform may determine that a particular category of POIs be chosen, unless one or more other factors, such as distance, override that preference. For example, one or more POIs may be determined as less useful if it is greater than a threshold distance, such as 100 to 300 meters, for example. In an embodiment, a relevance, or relevance score, may depend at least in part on a distance of a POI from an aspect of a route. For example, an educational institution may have a relevance score of 650 at a distance of 26-50 meters from an aspect of a route, while having a relevance score of 1000 at a distance of 0-25 meters from an aspect of a route. For example, petrol stations as a category may be ranked higher than banks as a category, which in turn may be ranked higher than ATMs as a category, etc. In an embodiment, a computing platform may prefer, based at least in part on a relevance value, POI information belonging to a more highly ranked category unless distance from an aspect of a textual explanation of a route is such that a POI having a lower ranked category may be more beneficial to a driver.

In an embodiment, for one or more categories of POIs, a relevance function or operation may be described according to one or more of the following, which may have one or more known computational approaches or techniques for particular implementations:

Linear decaying: such as if a relevance value may decrease linearly as a distance from a particular intersection, turn, or edge increases;

Piece-wise linear decaying: such as if a relevance value may decrease linearly for one or more distances, but the actual rate of the decrease may differ as the distance of the POI from a particular intersection, turn, or edge increases;

Abrupt decaying: such as if a relevance value may remain constant within an interval, but differ over one or more distances. In this circumstance, a relevance value may decrease abruptly if the distance increases and falls in another interval. In addition, there may be a cut off, such as at an end of a particular interval after which a relevance value may be approximated as zero.

It should be noted that, although aspects of the above system or process have been described in a particular order, the specific order is merely an example of a process and that claimed subject matter is of course not limited to the order described. It should also be noted, that the methods and processes described herein, may be capable of being performed by one or more computing platforms. In addition, the methods or processes described herein may be capable of being stored on a storage medium as one or more machine readable instructions that, if executed, may enable a computing platform to perform one or more actions. “Storage medium” as referred to herein relates to media capable of maintaining expressions which may be operated on, or executed by, by one or more machines. For example, a storage medium may comprise one or more storage devices for storing machine-readable instructions or information. Such storage devices may comprise any one of several media types including, for example, magnetic, optical or semiconductor storage media. However, these are merely examples of a storage medium and claimed subject matter is not limited in these respects.

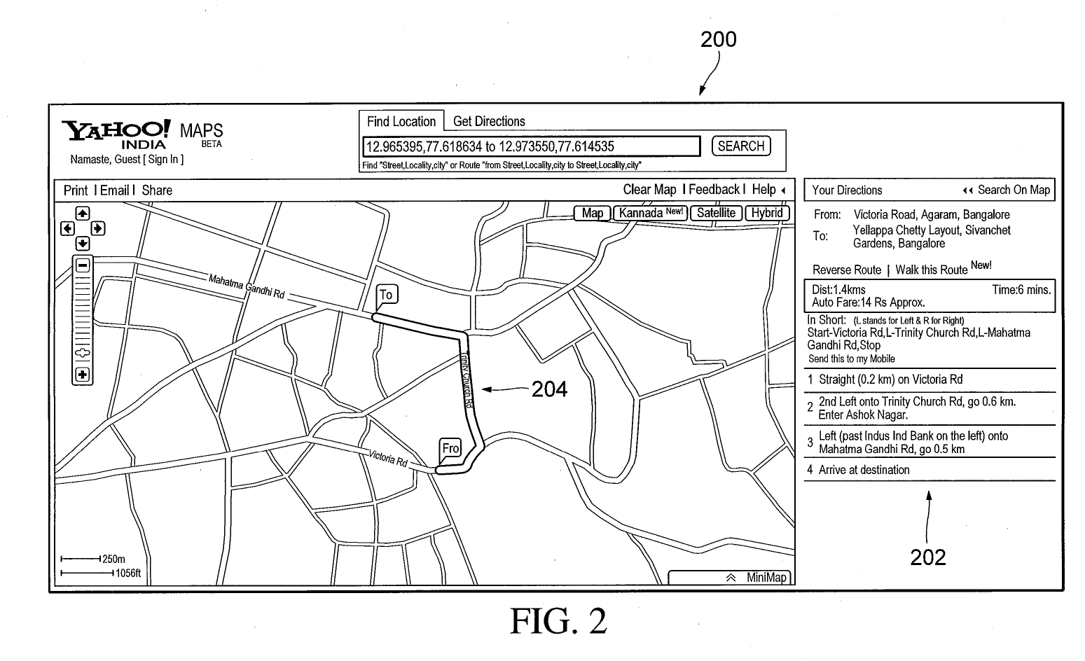

FIG. 2 is a schematic diagram of a display interface including one or more route directions in accordance with an embodiment 200. With regard to embodiment 200, a computing platform may display generated textual explanations of a route 202 including POI information. In addition, a computing platform may also display a graphical representation of the route 204. With regard to the textual explanation of the route, the explanation includes POI information, such as potential turn information (“2^{nd} left”), administration area information (“Enter Ashok Nagar”), and landmark information (“past Ind Bank on the left”) to assist a driver in navigating an intended route.

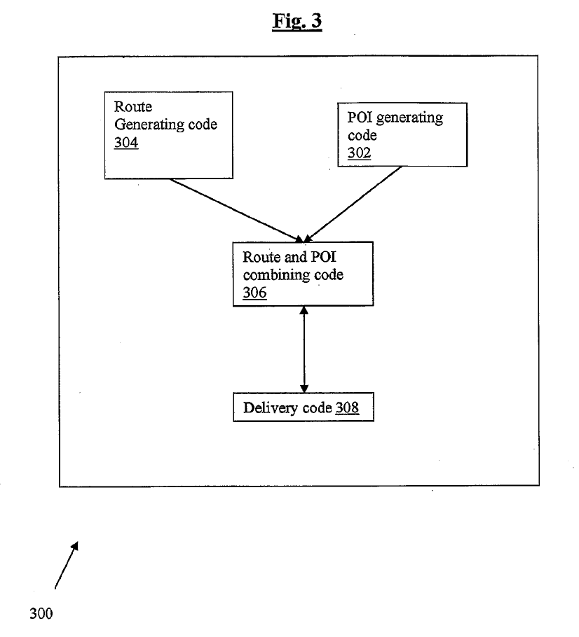

FIG. 3 is a schematic diagram of an application program in accordance with an embodiment 300. With regard to embodiment 300, an application program may comprise a POI generating code 302. POI generating code 302 may, as discussed above, gather information relating to one or more POIs, such as by employing a third party web site, a web crawler, a search engine, or the like. In addition, POI information may be gathered from one or more commercial data providers, such as CE Infosystems, of India, for example. In addition, POI generating code 302, may associate the gathered POIs with one or more turns based at least in part on stored geographic information and calculate a relevance value or score to associate with the gathered POIs and one or more turns. Embodiment 300 may further include a route generating code 304. Route generating code 304 may generate a structured representation of a route, such as through one or more of the processes described above. Under some circumstances, POI generating code 302 may gather and generate this information at least in response to a generated route from route generating code 304. Under other circumstances, POI generating code 302 may store, such as in a database or table, the gathered and generated information, for later use. Embodiment 300 may further include a Route and POI combining code 306. Route and POI combining code 306 may combine the generated structured representation of a route with generated or stored POI information, as described and shown above, at least in part to generate a textual explanation of a route including POI information. Embodiment 300 may further include a delivery code 308. Delivery code 308 may transmit the combined route and POI information to a user, such as by transmitting the information via a network to a computing platform, for example. It should, however, be noted that this is merely an example structure for code and that various structures may be used without departing from the scope of claimed subject matter.

It should be noted, that though described with regard to particular computing platforms performing one or more functions, an apparatus, system or process in accordance with an embodiment may be capable of being executed by, and corresponding functions may be performed on, one or more computing platforms. For example, in at least one embodiment a route generating code, a POI generating code, a route and POI combining code, a delivery code, or the like may be hosted on one or more computing platforms. Some code may be hosted on a computing platform, such as a server, while other code may be hosted on another computing platform, such as a client or a mobile device, for example. Accordingly, claimed subject matter is not limited in this regard.

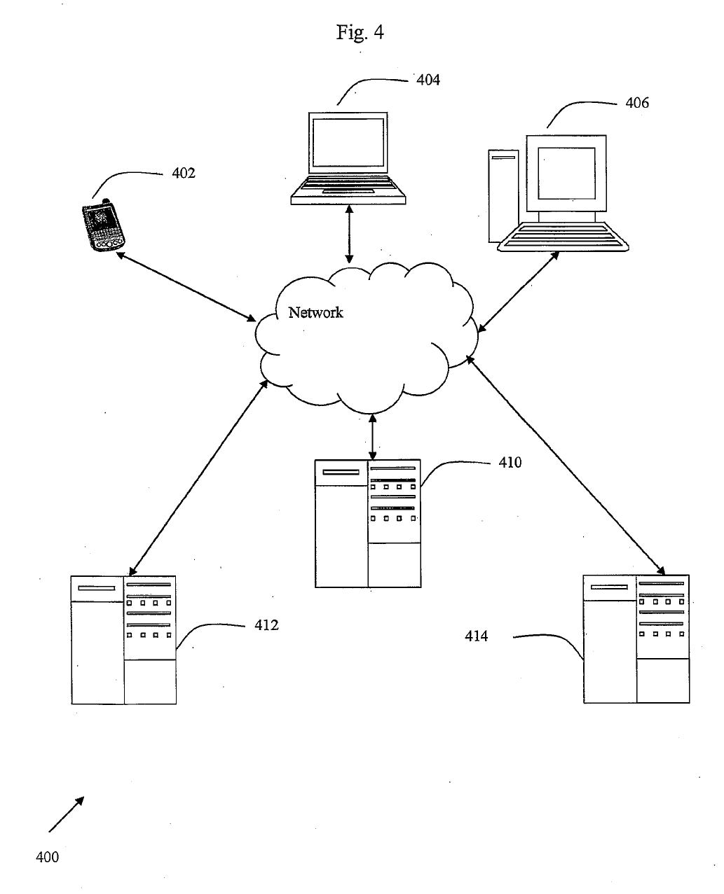

FIG. 4 is a schematic diagram of a system in accordance with an embodiment 400. With regard to embodiment 400, a user may initiate a route query using an application program or web page executing on a computing platform, such as computing platforms 402, 404, or 406. In an embodiment, the route query may be transmitted via a network to one or more computing platforms, such as servers 410, 412, or 414. In an embodiment, server 410 may, based at least in part on the route query, communicate with server 412 at least in part to generate a structured representation of a route, such as using one of the processes or methods described above. In addition, server 410, may further communicate with server 414 at least in part to obtain POI information which may have been gathered and associated with one or more aspects of a route, such as one or more turns, and may have had relevance scores generated, by server 414, such as by using one of the methods or processes discussed above, for example. In an embodiment, server 410 may further combine the POI information with the structured representation of a route and generate a textual explanation of route including the POI information. Furthermore, server 410 may transmit the combined information to the user via a network.

In the preceding description, various aspects of claimed subject matter have been described. For purposes of explanation, specific numbers, systems and/or configurations were set forth to provide a thorough understanding of the claimed subject matter. However, it should be apparent to one skilled in the art having the benefit of this disclosure that claimed subject matter may be practiced without the specific details. In other instances, features that would be understood by one of ordinary skill were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all such modifications and/or changes as fall within the true spirit of claimed subject matter.

1. A method comprising:
generating from stored geographic information a textual explanation of route directions that includes point of interest information, wherein said point of interest information includes at least one of the following: specifying the number of potential turns between two actual turns; landmark information based at least in part on proximity to an actual turn; or one or more political boundaries.

2. The method of claim 1, wherein generating a textual explanation includes generating a structured representation of a route from the stored geographic information.

3. The method of claim 1, wherein said generating comprises: generating a textual explanation without using a calculated position of a user.

4. The method of claim 1, wherein said generating comprises: generating a textual explanation without employing wireless signals to determine location.

5. The method of claim 1, and further comprising: selectively including said point of interest information for one or more intersections including one or more roads having inadequate identifying information.

6. The method of claim 5, wherein said one or more roads having inadequate identifying information comprise at least one of an unnamed road, a road that is not well known, and an inadequately marked road.

7. The method of claim 5, wherein a turn comprises an intersection of one or more roads.

8. The method of claim 7, wherein an intersection comprises one or more determined edges having an angle between them greater than a threshold value.

9. The method of claim 8, wherein said threshold value comprises a value between 20 degrees and 30 degrees.

10. An article comprising: a storage medium having instructions stored thereon, wherein said instructions, if executed by a computing platform, enable said computing platform to:
generate from stored geographic information a textual explanation of route directions that includes point of interest information, wherein said point of interest information includes at least one of the following: specifying the number of potential turns between two actual turns; landmark information based at least in part on proximity to an actual turn; or one or more political boundaries.

11. The article of claim 10, wherein said instructions, if executed by a computing platform, further enable said computing platform to generate a textual explanation by generating a structured representation of a route from the stored geographic information.

12. The article of claim 10, wherein said instructions, if executed by a computing platform, further enable said computing platform to: generate a textual explanation without use of a calculated position of a user.

13. The article of claim 10, wherein said instructions, if executed by a computing platform, further enable said computing platform to: generate a textual explanation without use of wireless signals to determine location.

14. The article of claim 10, wherein said instructions, if executed by a computing platform, enable said computing platform to: selectively include said point of interest information for one or more intersections including one or more roads having inadequate identifying information.

15. The article of claim 14, wherein said one or more roads having inadequate identifying information comprise at least one of an unnamed road, a road that is not well known, or an inadequately marked road.

16. The article of claim 14, wherein a turn comprises an intersection of one or more roads.

17. The article of claim 16, wherein an intersection comprises one or more determined edges having an angle between them greater than a threshold value.

18. The article of claim 17, wherein said threshold value comprises a value between 20 degrees and 30 degrees.

19. A system comprising:
a computing platform;
wherein said computing platform is adapted to generate from stored geographic information a textual explanation of route directions that includes point of interest information, wherein said point of interest information includes at least one of the following: specifying the number of potential turns between two actual turns; landmark information based at least in part on proximity to an actual turn; or one or more political boundaries.

20. The system of claim 19, wherein said computing platform is further adapted to generate a structured representation of a route from the stored geographic information.

21. The system of claim 19, wherein said computing platform is further adapted to generate a textual explanation without use of a calculated position of a user.

22. The system of claim 19, wherein said computing platform is further adapted to generate a textual explanation without use of wireless signals to determine location.

23. The system of claim 19, wherein said computing platform is further adapted to selectively include said point of interest information for one or more intersections including one or more roads having inadequate identifying information.

24. The system of claim 23, wherein said one or more roads having inadequate identifying information comprise at least one of an unnamed road, a road that is not well known, and an inadequately marked road.

25. The system of claim 23, wherein a turn comprises an intersection of one or more roads.

26. The system of claim 25, wherein an intersection comprises one or more determined edges having an angle between them greater than a threshold value.

27. The system of claim 26, wherein said threshold value comprises a value between 20 degrees and 30 degrees.

28. A system comprising:
means for generating a structured representation of a route from stored geographic information;
means for associating point of interest information with one or more portions of the structured representation of a route; and
means for generating a textual explanation of route directions that includes point of interest information based at least in part on the structured representation of a route and the associated point of interest information.

29. The system of claim 28, wherein said point of interest information includes at least one of the following: specifying the number of potential turns between two actual turns; landmark information based at least in part on proximity to an actual turn; or one or more political boundaries.

30. The system of claim 29, wherein said means for generating a textual explanation of a route is adapted to generate a textual explanation without use of a calculated position of a user.

31. The system of claim 29, wherein said means for generating a textual explanation of a route is adapted to generate a textual explanation without use of wireless signals to determine location.
